(19) United States
(12) Patent Application Publication
(10) Pub. No.: US 2015/0102947 A1
(43) Pub. Date: Apr. 16, 2015

(54) FILM-TYPE HAPTIC DEVICE, HAPTIC FEEDBACK ELECTRONIC DEVICE AND HAPTIC KEYBOARD

(71) Applicant: Samsung Electro-Mechanics Co., Ltd., Suwon (KR)

(72) Inventors: Il Kwon CHUNG, Suwon (KR); Byeong Sung Min, Suwon (KR); Hyun Ho Lim, Suwon (KR)

(73) Assignee: Samsung Electro-Mechanics Co., Ltd., Suwon (KR)

(21) Appl. No.: 14/107,586

(22) Filed: Dec. 16, 2013

(30) Foreign Application Priority Data
Oct. 14, 2013 (KR) 10-2013-0122199

(51) Int. Cl. G06F 3/01; H01H 13/85; G06F 3/041

(52) U.S. Cl. CPC G06F 3/016; G06F 3/0412; H01H 13/85
USPC 341/27; 340/407.2; 340/407.1

(57) ABSTRACT

There is provided a film-type haptic device including: a plate shaped base plate; at least one spacer provided on an edge of an upper surface of the base plate; an actuator including a film shaped polymer layer positioned on the spacer and supported by the spacer and first and second electrodes provided so as to closely and entirely cover both surfaces of the polymer layer, respectively; and an elastic plate adhered to an upper surface of the actuator. The film-type haptic device according to the present disclosure may significantly decrease consumption power consumed in vibration and allow a user to more accurately feel haptic sensation for touch input.

### CROSS-REFERENCE TO RELATED APPLICATION

This application claims the benefit of Korean Patent Application No. 10-2013-0122199 filed on Oct. 14, 2013, with the Korean Intellectual Property Office, the disclosure of which is incorporated herein by reference.

### BACKGROUND

The present disclosure relates to a film-type haptic device, an electronic haptic feedback device, and a haptic keyboard, and more particularly, to a film-type haptic device including a film-type actuator, a haptic feedback electronic device, and a haptic keyboard.

In accordance with recent user demand for electronic devices which are simple to use, a touch type device allowing for data to be input thereto through being touched has generally been used.

Currently, a haptic feedback device includes the concept of providing a an intuitive user interface and further diversifying feedback for user touches, in addition to the concept of allowing for the input of data through touching the electronic device.

Here, such a haptic feedback device has various advantages, such as compatibility with IT devices, in addition to being able to operate in a relatively small space, improved and simplified, in terms of operability, allowing for the specifications thereof to be changed, and high in user recognition.

Due to these advantages, haptic feedback devices have been widely used in electronic devices used in the fields of computing, traffic management, customer service, medicine, mobile communications devices and others.

As an actuator for implementing a haptic function, a piezoelectric-type actuator formed to have a bar shape has mainly been used.

Since a plurality of bar shaped actuators, as described above, may be mounted in an electronic device to vibrate the entire electronic device, a large amount of power may be consumed thereby. In addition, since the entire electronic device, rather than merely a display portion in contact with a finger of a user vibrates, user feedback may be unsatisfactory.

### SUMMARY

An aspect of the present disclosure may provide a film-type haptic device allowing for only a portion thereof in contact with a user's finger to be vibrated, an electronic haptic feedback device, and a haptic keyboard.

According to an aspect of the present disclosure, a film-type haptic device may include: a plate shaped base plate; at least one spacer provided on an edge of an upper surface of the base plate; an actuator including a film shaped polymer layer positioned on the spacer and supported by the spacer and first and second electrodes provided so as to closely and entirely cover both surfaces of the polymer layer, respectively; and an elastic plate adhered to an upper surface of the actuator.

The polymer layer may be formed of an electrostrictive polymer or a piezoelectric polymer.

The base plate may have a quadrilateral shape, and a pair of spacers may be provided along two sides of the base plate opposing each other.

The base plate may have a quadrilateral shape, and four spacers may be provided at four vertex positions of the base plate, respectively.

The spacer may be formed of a rubber material.

The elastic plate may be cover layer formed of a transparent material.

The base plate may be a display panel disposed in an internal space of an electronic device to display an image.

The elastic plate may be a touch panel sensing a user's touch.

All of the polymer layer and the first and second electrodes may be formed of transparent materials.

According to another aspect of the present disclosure, an electronic haptic feedback device may include: a case having an internal space formed therein; a plate shaped base plate received in the case; at least one spacer provided on an edge of an upper surface of the base plate; an actuator including a film shaped polymer layer positioned on the spacer and supported by the spacer and first and second electrodes provided so as to closely and entirely cover both surfaces of the polymer layer, respectively; and an elastic plate adhered to an upper surface of the actuator.

According to another aspect of the present disclosure, a haptic keyboard may include: a plate shaped base plate; at least one spacer provided on an edge of an upper surface of the base plate; an actuator including a film shaped polymer layer positioned on the spacer and supported by the spacer and first and second electrodes provided so as to closely and entirely cover both surfaces of the polymer layer, respectively; a module for sensing key input adhered to an upper surface of the actuator and a user's key input; and a keyboard cover provided on an upper surface of the module for sensing key input, and having an upper surface on which a position of an input key is represented.

The module for sensing key input may be a touch panel sensing a user's touch.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic exploded perspective view showing an electronic haptic feedback device according to an exemplary embodiment of the present disclosure;

FIG. 2 is a schematic internal cross-sectional view showing the electronic haptic feedback device according to the exemplary embodiment of the present disclosure;

FIG. 3 is a schematic exploded perspective view showing a film-type haptic device 100 according to the exemplary embodiment of the present disclosure;

FIG. 4 is a schematic internal perspective view showing the film-type haptic device 100 according to the exemplary embodiment of the present disclosure;

FIGS. 5A and 5B are conceptual views of a piezoelectric element when voltage is applied thereto;

FIGS. 6A and 6B are conceptual views for describing an operation principle of the film-type haptic device according to the present disclosure; and

FIG. 7 is a schematic exploded perspective view showing a haptic keyboard according to an exemplary embodiment of the present disclosure.

### DETAILED DESCRIPTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

Haptic Device and Haptic Feedback Electronic Device

Hereinafter, a film-type haptic device 100 and an electronic haptic feedback device 200 according an exemplary embodiment of the present disclosure will be described in detail.

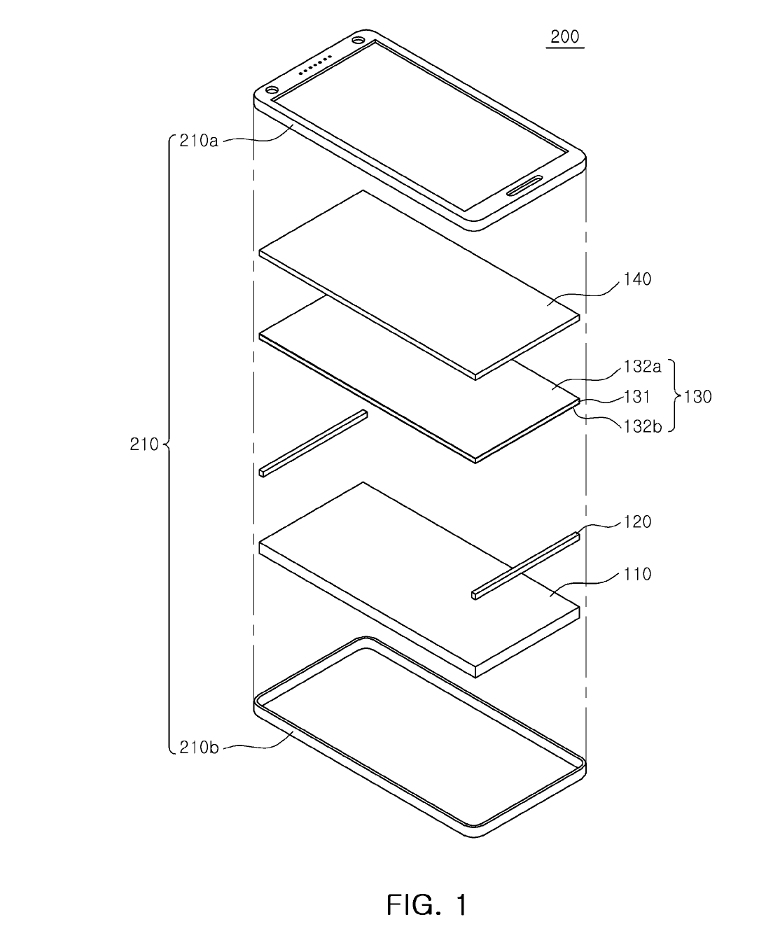

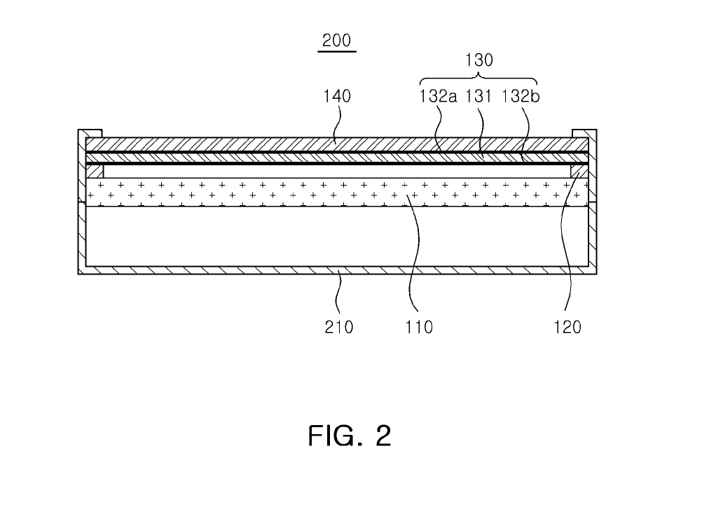

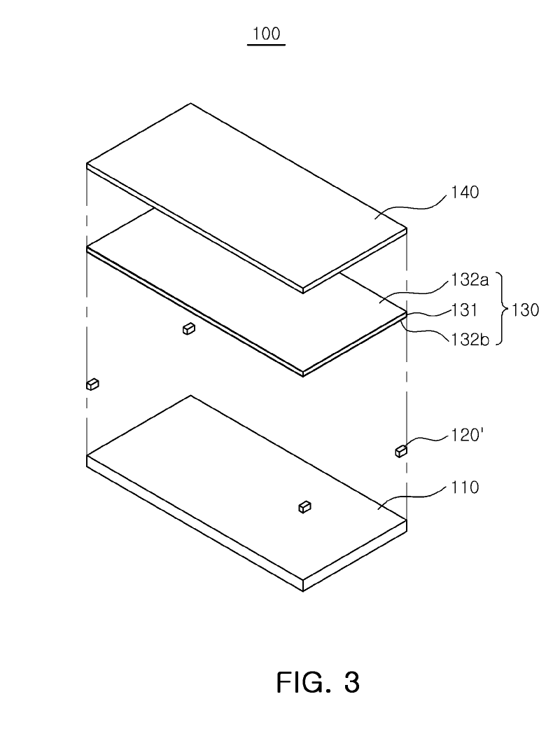

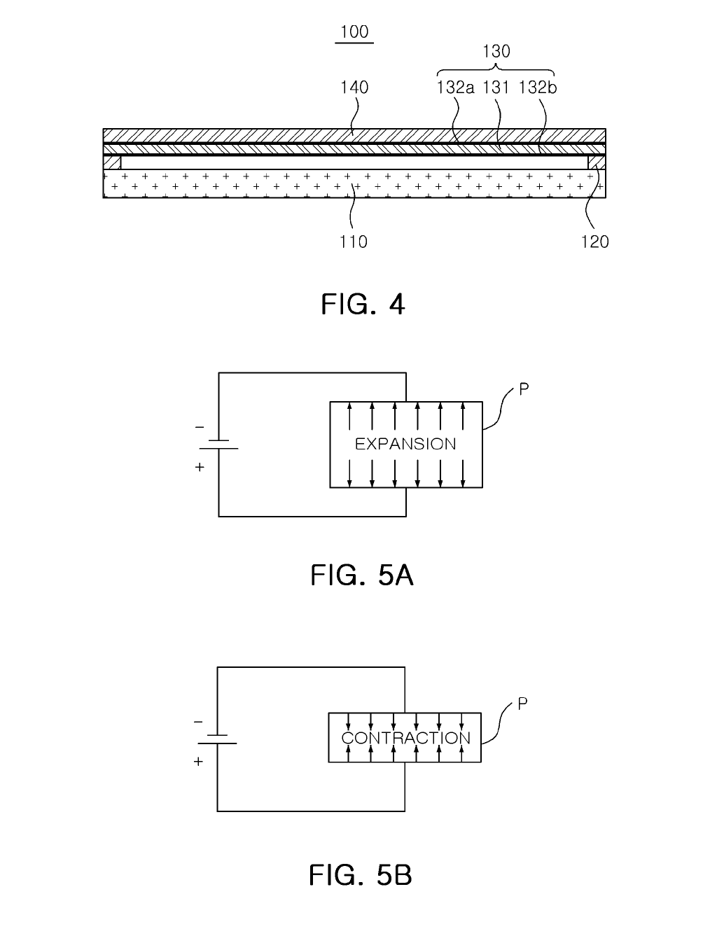

FIG. 1 is a schematic exploded perspective view showing the electronic haptic feedback device 200 according to an exemplary embodiment of the present disclosure, FIG. 2 is a schematic internal cross-sectional view showing the electronic haptic feedback device 200 according to the exemplary embodiment of the present disclosure, FIG. 3 is a schematic exploded perspective view showing a film-type haptic device 100 according to the exemplary embodiment of the present disclosure, and FIG. 4 is a schematic internal perspective view showing the film-type haptic device 100 according to the exemplary embodiment of the present disclosure.

Referring to FIGS. 1 through 4, the electronic haptic feedback device 200 according to the exemplary embodiment of the present disclosure may include a case 210 having an internal space formed therein and a film-type haptic device 100 positioned within the internal space.

In addition, the film-type haptic device 100 may include a plate-shaped base plate 110 received in the case 210, at least one spacer 120 provided on an upper surface of the base plate, a film-shaped actuator 130 supported by the spacer 120, and an elastic plate 140 adhered to an upper surface of the actuator 130.

The case 210 may be composed of an upper case 210a and a lower case 210b, and the upper and lower cases 210a and 210b are coupled to each other to thereby form the internal space.

The film-type haptic device 100 may be positioned in the internal space.

Here, the film-type haptic device 100, provided to implement required vibrations, is an internal component of the electronic haptic feedback device 200 requiring a response depending on external contact pressure.

The base plate 110 may have a quadrilateral shape, and be a display panel 110 disposed within an internal space of an electronic device. Hereinafter, for convenience of explanation, the base plate and the display panel are denoted by the same reference numeral 110.

Here, as the display panel 110, there are a liquid crystal display (LCD) panel, alight emitting diode (LED) panel, a plasma display panel (PDP) panel, and the like. However, the present disclosure is not limited thereto, and various display panels applied by those skilled in art may be used.

The spacers 120 and 120′ may be formed of a rubber material, and at least one spacer may be provided on an edge of the upper surface of the base plate 110.

In addition, a pair of the spacers 120 may be provided along two sides of the base plate 110 opposing each other as shown in FIG. 1.

Further, the spacers 120′ may be provided at four vertex positions of the base plate 110, respectively, as shown in FIG. 3.

Meanwhile, the spacers 120 and 120′ may be provided to secure a gap between the base plate 110 and the actuator 130 to secure a space for vertical vibrations of the actuator 130.

The actuator 130 may include a polymer layer 131 having a film shape and first and second electrodes 132a and 132b provided so as to closely and entirely cover both surfaces of the polymer layer 131, respectively.

The polymer layer 131 may be formed of an electrostrictive polymer or piezoelectric polymer deformed in a vertical or horizontal direction when a voltage is applied to the polymer layer 131. However, the present disclosure is not limited thereto, and the polymer layer 131 may be formed of various materials such as an ionic polymer, a dielectric elastomer, or the like.

Further, in order to allow a user to see an image displayed on the display panel 110, the actuator 130 may be manufactured to be transparent. To this end, the polymer layer 131 and the first and second electrodes 132a and 132b may be formed of transparent materials.

Meanwhile, the first and second electrodes 132a and 132b may be formed of copper (Cu), silver (Ag) indium tin oxide (ITO), a conductive polymer, or the like. However, the present disclosure is not limited thereto, and various materials known in the art may be used as long as the voltage may be applied to the polymer layer 131.

Bus electrodes (not shown) may be connected to the first and second electrodes 132a and 132b, respectively, and the voltage may be applied through the bus electrodes.

The elastic plate 140 may be adhered to the upper surface of the actuator 130, that is, an upper surface of the first electrode 132a.

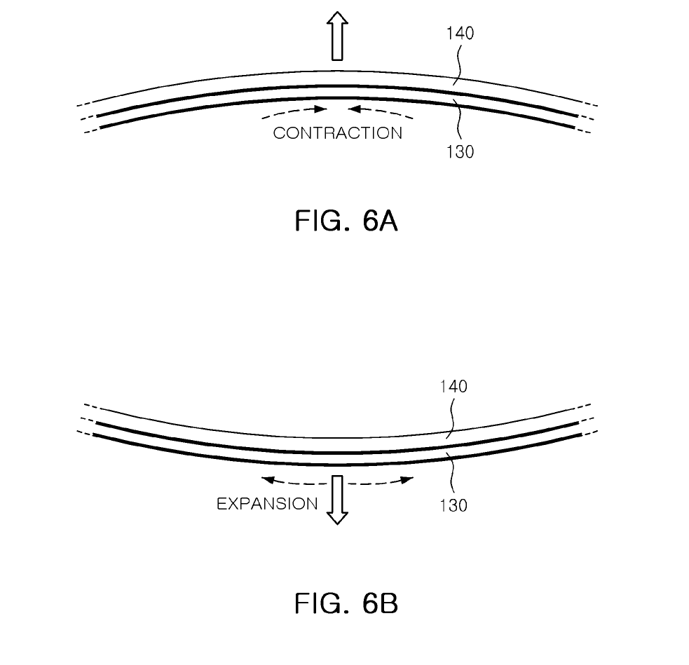

Therefore, when the voltage is applied to the polymer layer 131 through the first and second electrodes 132a and 132b, since the polymer layer 131 may be contracted or expanded as shown in FIGS. 6A and 6B, and the elastic plate 140 is not contracted or expanded although the voltage is applied thereto, vertical displacement may be generated in an assembly of the actuator 130 and the elastic plate 140. Haptic feedback may be transferred to the user through this displacement.

In addition, since the entire haptic feedback electronic device 200 or the entire haptic device 100 does not vibrate, and only the assembly of the actuator 131 and the elastic plate 140 vibrates, power consumption may be significantly decreased.

In addition, there is an advantage in that since only the portion of the elastic plate 140 is in direct contact with a finger of a user, or the like, vibrates, user feedback may be further directly transferred.

Meanwhile, the elastic plate 140 may be a cover layer formed of a transparent material or a touch panel sensing a user's touch.

Hereinafter, an operation principle of the film-type haptic device 100 according to the exemplary embodiment of the present disclosure will be described in detail.

FIGS. 5A and 5B are conceptual views of a piezoelectric element P when voltage is applied thereto, and FIGS. 6A and 6B are conceptual views for describing an operation principle of the film-type haptic device 100 according to the present disclosure.

Referring to FIGS. 5A and 5B, when the piezoelectric element P formed of an electro-active polymer or piezoelectric polymer has voltage applied thereto in a vertical direction; displacement is generated in the same direction as a polarization direction, that is, the vertical direction. Therefore, when the voltage is applied in a form of a pulse having a predetermined frequency, contraction and expansion may be repeated in the vertical direction, such that vibrations are generated.

Meanwhile, in the piezoelectric element P, displacement may be generated in the same direction as the polarization direction, that is, the vertical direction of the piezoelectric element P, but at the same time, displacement may also be generated in a direction perpendicular to the polarization direction, that is, a horizontal direction of the piezoelectric element P. However, since this displacement in the horizontal direction is significantly small, as compared to the displacement in the vertical direction, the displacement in the horizontal direction is insufficient for being used as vibration for haptic feedback.

However, the film-type haptic device 100 according to the present disclosure may utilize the displacement in the horizontal direction as vibrations for haptic feedback.

Referring to FIGS. 6A and 6B, in the film-type haptic device 100 according to the present disclosure, the elastic plate 140 is adhered to the upper surface of the actuator 130, such that when the polymer layer 131 is contracted, bending is generated upwardly due to an interaction between the polymer layer 131 and the elastic plate 140 that will not be contracted, as shown in FIG. 6A, and when the polymer layer 131 is expanded, the bending is generated downwardly due to the interaction between the polymer layer 131 and the elastic plate 140 that will not be expanded as shown in FIG. 6B.

In the film-type haptic device 100 according to the exemplary embodiment of the present disclosure, since the film shaped polymer layer 131 is provided, in the case of using bending displacement as described above, sufficient vibrations may be obtained. Therefore, these vibrations may be utilized as vibrations for haptic feedback.

In other words, when the voltage is applied to the polymer layer 131 in a form of a pulse having a predetermined frequency, vibrations in the vertical direction may be obtained, and the vibrations obtained may be utilized as vibrations for haptic feedback.

Haptic Keyboard

Hereinafter, the haptic keyboard 300 according to an exemplary embodiment of the present disclosure will be described with reference to the accompanying drawings. However, the same components as the above-mentioned components will be denoted by the same reference numerals and a detailed description thereof will be omitted.

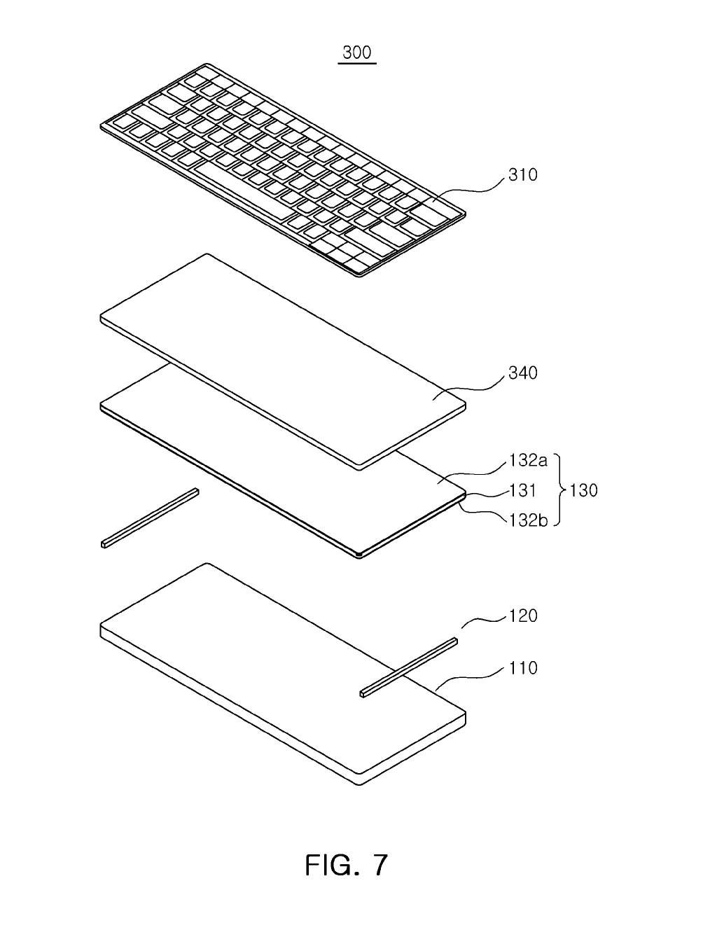

FIG. 7 is a schematic exploded perspective view showing a haptic keyboard 300 according to the exemplary embodiment of the present disclosure.

Referring to FIG. 7, the haptic keyboard 300 according to the exemplary embodiment of the present disclosure may include a plate-shaped base plate 110, at least one spacer 120 provided on an upper surface of the base plate, a film-shaped actuator 130 supported by the spacer 120, a module 340 for sensing key input adhered to an upper surface of the actuator 130, and a keyboard cover 310 provided on an upper surface of the module 340 for sensing key input.

The module 340 for sensing key input may be adhered to the upper surface of the actuator 130, that is, an upper surface of the first electrode 132a.

Therefore, when the voltage is applied to the polymer layer 131 through the first and second electrodes 132a and 132b, since the polymer layer 131 may be contracted or expanded as shown in FIGS. 6A and 6B, but the module 340 for sensing key input is not contracted or expanded even in the case that voltage is applied thereto, vertical displacement may be generated in an assembly of the actuator 130 and the module 340 for sensing key input. Haptic feedback may be transferred to the user through this displacement.

In addition, according to the present disclosure, the entire haptic keyboard 300 does not vibrate, but only the assembly of the actuator 131, the module 340 for sensing key input, and the keyboard cover 310 vibrates, such that power consumption may be significantly decreased.

Further, there is an advantage in that since only the portion of the keyboard cover 310 directly in contact with a user's finger, or the like, vibrates, a sense may be further directly transferred.

Meanwhile, the module 340 for sensing key input may be a touch panel sensing a touch of the user. In addition, the module 340 for sensing key input may be a device sensing a key input position of the user by an electrostatic method, a method of using a piezoelectric resistor, or the like. However, the present disclosure is not limited thereto, but may be implemented by various methods known in the art.

The keyboard cover 310 may be attached to the upper surface of the module 340 for sensing key input, and a position of input key will be represented on an upper surface thereof.

As set forth above, in the film-type haptic device, the electronic haptic feedback device, and the haptic key board according to exemplary embodiments of the present disclosure, since vibrations are only generated in the portion thereof in contact with the user's finger, the power consumption may be decreased, and at the same time, a user may more accurately feel haptic sensation for touch input.

While exemplary embodiments have been shown and described above, it will be apparent to those skilled in the art that modifications and variations could be made without departing from the spirit and scope of the present disclosure as defined by the appended claims.

What is claimed is:

1. A film-type haptic device comprising:
a plate shaped base plate;
at least one spacer provided on an edge of an upper surface of the base plate;
an actuator including a film shaped polymer layer positioned on the spacer and supported by the spacer and first and second electrodes provided so as to closely and entirely cover both surfaces of the polymer layer, respectively; and
an elastic plate adhered to an upper surface of the actuator.

2. The film-type haptic device of claim 1, wherein the polymer layer is formed of an electrostrictive polymer or a piezoelectric polymer.

3. The film-type haptic device of claim 1, wherein the base plate has a quadrilateral shape, and a pair of spacers are provided along two sides of the base plate opposing each other.

4. The film-type haptic device of claim 1, wherein the base plate has a quadrilateral shape, and four spacers are provided at four vertex positions of the base plate, respectively.

5. The film-type haptic device of claim 1, wherein the spacer is formed of a rubber material.

6. The film-type haptic device of claim 1, wherein the elastic plate is a cover layer formed of a transparent material.

7. The film-type haptic device of claim 1, wherein the base plate is a display panel disposed in an internal space of an electronic device to display an image.

8. The film-type haptic device of claim 1, wherein the elastic plate is a touch panel sensing a user's touch.

9. The film-type haptic device of claim 1, wherein all of the polymer layer and the first and second electrodes are formed of transparent materials.

10. An electronic haptic feedback device comprising:
a case having an internal space formed therein;
a plate shaped base plate received in the case;
at least one spacer provided on an edge of an upper surface of the base plate;
an actuator including a film shaped polymer layer positioned on the spacer and supported by the spacer and first and second electrodes provided so as to closely and entirely cover both surfaces of the polymer layer, respectively; and
an elastic plate adhered to an upper surface of the actuator.

11. A haptic keyboard comprising:
a plate shaped base plate;
at least one spacer provided on an edge of an upper surface of the base plate;
an actuator including a film shaped polymer layer positioned on the spacer and supported by the spacer and first and second electrodes provided so as to closely and entirely cover both surfaces of the polymer layer, respectively;
a module for sensing key input adhered to an upper surface of the actuator and a user's key input; and
a keyboard cover provided on an upper surface of the module for sensing key input, and having an upper surface on which a position of an input key is represented.

12. The haptic keyboard of claim 11, wherein the module for sensing key input is a touch panel sensing a user's touch.
